(19) United States
(12) Patent Application Publication
(10) Pub. No.: US 2007/0216231 A1
(43) Pub. Date: Sep. 20, 2007

(54) Switch module apparatus, single switch apparatus, and vehicle including the same

(75) Inventors: Brian D. Deery, Clayton, NC (US); Wesley A. Jorgensen, Raleigh, NC (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/375,976

(22) Filed: Mar. 15, 2006

(51) Int. Cl. H01H 19/14

(52) U.S. Cl. 307/115

(57) ABSTRACT

A single rocker switch apparatus includes a single rocker switch and a switch module operatively associated therewith. The rocker switch includes an operator having a non-actuated position, a first actuated position, a second different actuated position, and first and second outputs corresponding to the respective first and second actuated positions. The switch module includes first and second inputs electrically interconnected with the respective first and second outputs, a first electronic memory receiving the first input and responsively providing a first toggle switch function, a first power output toggled by the first toggle switch function responsive to the first output and structured to power a first powered device, a second electronic memory receiving the second input and responsively providing a second toggle switch function, and a second power output toggled by the second toggle switch function responsive to the second output and structured to power a second powered device.

### BACKGROUND OF THE INVENTION

1. Field of the Invention

This invention relates to electrical switches and, more particularly, to switch assemblies including electrical components electrically connected between switch terminals and a powered device. The invention also relates to vehicles including one or more electrical switches.

2. Background Information

Electrical switches employed in low voltage applications, such as for example, rocker switches used in vehicles, have a rocker actuator member, pivotal about an axis and mounted on a switch housing. The actuator is pivoted by a user until contact is made with one of two stationary contacts, thus completing the electrical circuit and providing electrical current for functions, such as for example, energizing an electric motor to open a vehicle window or to adjust a side view mirror. A self-centering mechanism, such as a spring, returns the switch to the neutral position. On the base of the switch there is typically a plurality of electrical connecting terminals. These terminals are often electrically connected to complete the electrical circuit, within a vehicle electrical system, for example, by soldering wiring or plugging in wiring to the terminals. Similar switches are also used in a variety of low voltage applications outside of the automotive or motorcycle industries. See, for example, U.S. Pat. No. 6,930,269.

Typically, such rocker switches are limited in functionality by the number and variety of electrical components that can be electrically connected within the switch housing. Due to the ever-increasing demands for more and more electrical operating, monitoring, and control devices for vehicles, the space required for installation of these devices continuously decreases while demand for low-cost, miniaturized but complex versions of such devices, especially switches, increases. Constrained by the switch housing size and permanent connection of these internal electrical components, existing switches are limited in scope and incapable of performing many complex functions.

It is known to provide illuminated rocker switches for controlling, for example, accessory functions such as automotive door locks, power window lift motors, windshield wiper controls, hazard light switches, cruise controls, electric window de-icers, to name a few of the functions for which rocker switches are suitable. It is also known to provide an automotive cruise control master rocker switch where separate indicia on the switch actuator are illuminated to indicate where the user is to provide tactile force on the rocker for a desired state of actuation, and to provide a separate illumination when the switch has been actuated to activate the cruise control function. See, for example, U.S. Pat. No. 5,336,859.

U.S. Pat. No. 6,642,460 discloses a switch assembly including an external customizing printed circuit board electrically connected to the terminals on the base of an electrical switch. Electrical components, such as resistors and capacitors, may be soldered to the circuit board, as a subassembly. This circuit board subassembly may be slid over the electrical terminals on the base of an existing switch.

There is room for improvement in switches.

There is a need to expand the functionality of switches in applications, such as for example vehicles, where space is limited.

### SUMMARY OF THE INVENTION

These needs and others are met by embodiments of the invention, which provide a single switch assembly including a switch, two toggle switch functions, an electronic memory having two inputs and two outputs, and two toggle power outputs driven by the outputs of the electronic memory.

In accordance with one aspect of the invention, a vehicle comprises: at least one single switch, each of the at least one single switch comprising: an operator including a non-actuated position, a first actuated position, and a second different actuated position, a first output corresponding to the first actuated position, and a second output corresponding to the second different actuated position; at least one switch module, each of the at least one switch module being operatively associated with a corresponding one of the at least one single switch, each of the at least one switch module comprising: a first input electrically interconnected with the first output of the corresponding one of the at least one single switch, a first electronic memory receiving the first input and responsively providing a first toggle switch function, a first power output toggled by the first toggle switch function responsive to the first output of the corresponding one of the at least one single switch, a second input electrically interconnected with the second output of the corresponding one of the at least one single switch, a second electronic memory receiving the second input and responsively providing a second toggle switch function, and a second power output toggled by the second toggle switch function responsive to the second output of the corresponding one of the at least one single switch; and at least a pair of powered devices, each pair of the at least a pair of powered devices comprising a first powered device powered by the first power output of a corresponding one of the at least one switch module and a second powered device powered by the second power output of the corresponding one of the at least one switch module.

Each of the at least one switch module may further comprise a processor including a non-volatile memory having the first and second electronic memories.

The first toggle switch function of the first electronic memory may be structured to receive the first input corresponding to the first actuated position and responsively toggle power to the first powered device; and the second toggle switch function of the second electronic memory may be structured to receive the second input corresponding to the second actuated position and responsively toggle power to the second powered device.

Each of the at least one single switch may be a single rocker switch which further comprises a first indicator driven by the first power output and a second indicator driven by the second power output.

As another aspect of the invention, a single switch apparatus comprises: a single switch comprising: an operator including a non-actuated position, a first actuated position, and a second different actuated position, a first output corresponding to the first actuated position, and a second output corresponding to the second different actuated position; and a switch module operatively associated with the single switch, the switch module comprising: a first input electrically interconnected with the first output of the single switch, a first electronic memory receiving the first input and responsively providing a first toggle switch function, a first power output toggled by the first toggle switch function responsive to the first output of the single switch, the first power output being structured to power a first powered device, a second input electrically interconnected with the second output of the single switch, a second electronic memory receiving the second input and responsively providing a second toggle switch function, and a second power output toggled by the second toggle switch function responsive to the second output of the single switch, the second power output being structured to power a second powered device.

The first toggle switch function of the first electronic memory may be structured to receive the first input corresponding to the first actuated position and responsively toggle power to the first powered device; and the second toggle switch function of the second electronic memory may be structured to receive the second input corresponding to the second actuated position and responsively toggle power to the second powered device.

As another aspect of the invention, a switch module apparatus for a single switch of a vehicle, the single switch comprising an operator including a non-actuated position, a first actuated position, and a second different actuated position; a first output corresponding to the first actuated position; and a second output corresponding to the second different actuated position; the switch module apparatus comprising: a first input structured to be electrically connected to the first output of the single switch; a first electronic memory receiving the first input and responsively providing a first toggle switch function; a first power output toggled by the first toggle switch function responsive to the first output of the single switch, the first power output being structured to power a first powered device; a second input structured to be electrically connected to the second output of the single switch; a second electronic memory receiving the second input and responsively providing a second toggle switch function; and a second power output toggled by the second toggle switch function responsive to the second output of the single switch, the second power output being structured to power a second powered device.

### BRIEF DESCRIPTION OF THE DRAWINGS

A full understanding of the invention can be gained from the following description of the preferred embodiments when read in conjunction with the accompanying drawings in which:

FIG. 1 is a block diagram of a vehicle including rocker switches, switch modules and powered devices in accordance with an embodiment of the invention.

FIG. 2 is a block diagram in schematic form of a switch module apparatus in accordance with an embodiment of the invention.

### DESCRIPTION OF THE PREFERRED EMBODIMENTS

As employed herein, the statement that a part is “electrically interconnected with” one or more other parts shall mean that the parts are directly electrically connected together or are electrically connected together through one or more electrical conductors or generally electrically conductive intermediate parts. Further, as employed herein, the statement that a part is “electrically connected to” one or more other parts shall mean that the parts are directly electrically connected together or are electrically connected together through one or more electrical conductors.

As employed herein, the term “land vehicle” shall expressly include, but not be limited by, any land-based vehicles having pneumatic tires, any rail-based vehicles, any maglev vehicles, automobiles, cars, trucks, station wagons, sport-utility vehicles (SUVs), recreational vehicles, all-terrain vehicles, vans, buses, motorcycles, mopeds, campers, trailers, or bicycles.

As employed herein, the term “marine vehicle” shall expressly include, but not be limited by, any water-based vehicles, ships, boats, other vessels for travel on water, submarines, or other vessels for travel under water.

As employed herein, the term “air vehicle” shall expressly include, but not be limited by, any air-based vehicles, airplanes, jets, aircraft, airships, balloons, blimps, or dirigibles.

As employed herein, the term “vehicle” shall expressly include, but not be limited by, any land vehicles, marine vehicles, or air vehicles.

As employed herein, the term “powered device” shall expressly include, but not be limited by, devices powered by a low voltage; and devices powered by power within a vehicle, such as for example and without limitation, vehicle accessory functions such as door locks, power windows, side view mirrors, windshield wipers, lights such as hazard lights, spot lights or other vehicle lights, cruise controls, electric window de-icers, baggage locks and fans.

As employed herein, the term “number” shall mean one or an integer greater than one (i.e., a plurality).

The invention is described in association with a rocker switch for a vehicle, such as, for example, a motorcycle, although the invention is applicable to a wide range of vehicles, switches or sensors.

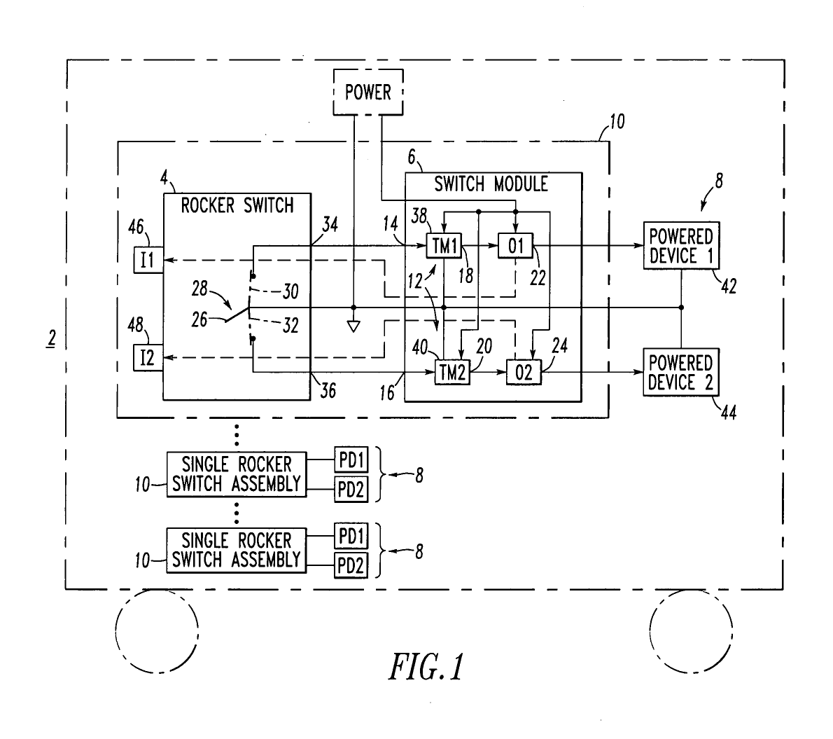

Referring to FIG. 1, a vehicle 2 includes a number of single rocker switches 4, a number of switch modules 6 and a number of pairs of powered devices 8. As will be explained, a single rocker switch assembly 10, which includes the rocker switch 4 and the switch module 6, further includes an electronic memory 12 having two inputs 14,16 and two outputs 18,20, and two toggle power outputs 22,24 driven by the respective electronic memory outputs 18,20.

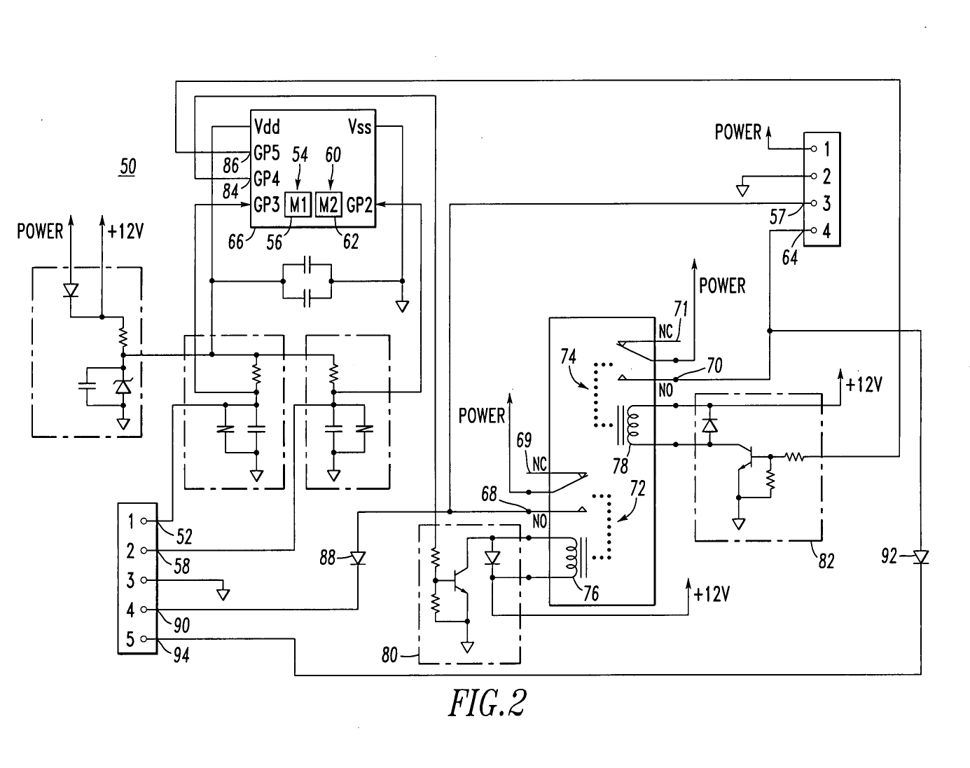

The single rocker switch 4 includes an operator 26 having a non-actuated position 28, a first actuated position 30 (shown in phantom line drawing), and a second different actuated position 32 (shown in phantom line drawing). The single rocker switch 4 also includes a first output 34 corresponding to the first actuated position 30, and a second output 36 corresponding to the second different actuated position 32. As shown, the switch module 6 is operatively associated with the corresponding single rocker switch 4. The first input 14 is electrically interconnected with the first output 34 of the corresponding single rocker switch 4. A first electronic memory 38 (TM1) receives the first input 14 and responsively provides a first toggle switch function, as will be described, below, in connection with FIG. 2. The first power output 22 is toggled by the first toggle switch function responsive to the first rocker switch output 34. The second input 16 is electrically interconnected with the second output 36 of the corresponding single rocker switch 4. A second electronic memory 40 (TM2) receives the second input 16 and responsively provides a second toggle switch function. The second power output 24 is toggled by the second toggle switch function responsive to the second rocker switch output 36. The pair of powered devices 8 includes a first powered device 42 powered by the first power output 22 and a second powered device 44 powered by the second power output 24.

### EXAMPLE 1

Although not required, the rocker switch 4 includes a first indicator 46 (I1) driven by the first power output 22 and a second indicator 48 (I2) driven by the second power output 24. In this manner, feedback to the user (not shown) of the powered or unpowered state of the pair of output devices 42,44 is provided by the respective indicators 46,48.

### EXAMPLE 2

The switch module 6 is disposed between the single rocker switch 4 and the two powered devices 8 being controlled. When the single rocker switch 4 is actuated to the first actuated position 30 (shown in phantom line drawing), the switch module 6 toggles power to the first powered device 42. When the single rocker switch 4 is actuated to the opposite second actuated position 32 (shown in phantom line drawing), the switch module 6 toggles power to the second powered device 44. For example, if the device 42 is initially in the powered state, and the single rocker switch 4 is actuated to the first actuated position 30, then the switch module 6 toggles power off to the device 42. As another example, if the device 44 is initially in the non-powered state, and the single rocker switch 4 is actuated to the second actuated position 32, then the switch module 6 toggles power on to the device 44.

### EXAMPLE 3

FIG. 2 shows a switch module apparatus 50 for a single rocker switch, such as the single rocker switch 4 of the vehicle 2 of FIG. 1. The switch module apparatus 50 may be the same as or similar to the switch module 6 of FIG. 1. The switch module apparatus 50 includes a first input 52 structured to be electrically interconnected with the first rocker switch output 34, a first electronic memory 54 (M1) receiving the first input 52 and responsively providing a first toggle switch function 56, and a first power output 57 toggled by the first toggle switch function 56 responsive to the first rocker switch output 34. The first power output 57 is structured to power a first powered device, such as the powered device 42 of FIG. 1.

The switch module apparatus 50 also includes a second input 58 structured to be electrically interconnected with the second rocker switch output 36 (FIG. 1), a second electronic memory 60 (M2) receiving the second input 58 and responsively providing a second toggle switch function 62, and a second power output 64 toggled by the second toggle switch function 62 responsive to the second rocker switch output 36. The second power output 64 is structured to power a second powered device, such as the powered device 44 of FIG. 1.

### EXAMPLE 4

In the example shown in FIG. 2, the switch module 50 includes a suitable processor 66 (e.g., without limitation, PIC® model 12F629, marketed by Microchip Technology Inc. of Chandler, Ariz.) including a non-volatile electronic memory having the first and second electronic memories 54,60 (e.g., without limitation, two sections of the non-volatile memory). The processor 66, as shown, includes two inputs GP2,GP3 and two outputs GP4,GP5. The processor 66 periodically (e.g., without limitation, several hundred times per second); repeating after a suitable time period) executes a routine that: (1) reads the two inputs GP2,GP3; (2) determines the new state of the two outputs GP4,GP5; and (3) outputs the new state to the two outputs GP4,GP5, respectively. The second step determines the new state of the output GP4, as follows. If the input GP2 is zero, then the new state of the output GP4 is unchanged. Otherwise, if the input GP2 is one, then the new state of the output GP4 is toggled. In other words, GP4=1−GP4 (i.e., the opposite of what it was before being toggled). It will be appreciated that the processor routine functions in a like manner for the input GP3 and the output GP5 as was discussed, above, for the input GP2 and the output GP4.

### EXAMPLE 5

As an alternative, the electronic memories 38,40 of the switch module 6 of FIG. 1 may be formed from first and second non-volatile digital logic circuits upon startup.

### EXAMPLE 6

As another alternative, the electronic memories 38,40 of the switch module 6 of FIG. 1 may be formed from first and second non-volatile latches.

### EXAMPLE 7

As non-limiting examples, the first powered device 42 of FIG. 1 may be a powered vehicle spot light and the second powered device 44 may be a cruise control.

### EXAMPLE 8

As another non-limiting example, one of the first and second powered devices 42,44 of FIG. 1 may be a powered hazard light, where an external vehicle light is flashed by the switch assembly 10. Here, one of the power outputs 22,24 is oscillated by the switch assembly 10, alternately powering and then un-powering the powered device (e.g., an external warning light).

### EXAMPLE 9

The toggle switch functions 56,62 of Example 3 may be implemented through any of the electronic memories of Examples 3-6. For example, the first toggle switch function 56 of the first electronic memory 54 is structured to receive the first input 52 corresponding to the first actuated position 30 (FIG. 1) and responsively toggle power to the first powered device 42. The second toggle switch function 62 of the second electronic memory 60 is structured to receive the second input 58 corresponding to the second actuated position 32 (FIG. 1) and responsively toggle power to the second powered device 44.

### EXAMPLE 10

Further to Example 9, when the first powered device 42 is powered and when the first toggle switch function 56 of the first electronic memory 54 receives the first input 52 corresponding to the first actuated position 30 (FIG. 1), the first power output 57 responsively removes power from the first powered device 42.

### EXAMPLE 11

Further to Examples 9 and 10, when the second powered device 44 is unpowered and when the second toggle switch function 62 of the second electronic memory 60 receives the second input 58 corresponding to the second actuated position 32 (FIG. 1), the second power output 64 responsively restores power to the second powered device 44.

### EXAMPLE 12

In the example shown in FIG. 2, the first and second power outputs 57,64 are driven by the normally open (NO) contacts 68,70 of electro-mechanical relays 72,74, respectively. The coils 76,78 of the relays 72,74 are driven by suitable coil driver circuits 80,82, which are driven by the outputs 84 (GP4), 86 (GP5), respectively, of the processor 66. Although NO contacts 68,70 are shown, the first and second power outputs 57,64 may alternatively be driven by normally closed (NC) contacts, such as 69,71.

### EXAMPLE 13

As an alternative, the toggle power outputs 22,24 of the switch module 6 of FIG. 1 may be formed from any suitable power output device, such as for example and without limitation, field effect transistors or solid state relays.

### EXAMPLE 14

When the first power output 57 of FIG. 2 is unpowered and when the first toggle switch function 56 of the first electronic memory 54 receives the first input 52 corresponding to the first actuated position 30 (FIG. 2), the first power output 57 is structured to restore power to the first powered device 42.

### EXAMPLE 15

When the second power output 64 is powered and when the second toggle switch function 62 of the second electronic memory 60 receives the second input 58 corresponding to the second actuated position 32 (FIG. 1), the second power output 64 is structured to remove power from the second powered device 44.

### EXAMPLE 16

As shown in FIG. 2, the first power output 57 is structured to power the first powered device 42 (FIG. 1). A diode 88 is electrically connected between the first power output 57 and a first indicator output 90. In this manner, current from the first power output 57, when energized, flows through the forward-biased diode 88 to the first indicator output 90, which is structured to power an indicator, such as indicator 46 of FIG. 1.

A diode 92 is electrically connected between the second power output 64 and a second indicator output 94. In this manner, current from the second power output 64, when energized, flows through the forward-biased diode 92 to the second indicator output 94, which is structured to power an indicator, such as indicator 48 of FIG. 1.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A vehicle comprising:
at least one single switch, each of said at least one single switch comprising:
an operator including a non-actuated position, a first actuated position, and a second different actuated position,
a first output corresponding to said first actuated position, and
a second output corresponding to said second different actuated position;
at least one switch module, each of said at least one switch module being operatively associated with a corresponding one of said at least one single switch, each of said at least one switch module comprising:
a first input electrically interconnected with the first output of the corresponding one of said at least one single switch,
a first electronic memory receiving said first input and responsively providing a first toggle switch function,
a first power output toggled by said first toggle switch function responsive to the first output of the corresponding one of said at least one single switch,
a second input electrically interconnected with the second output of the corresponding one of said at least one single switch,
a second electronic memory receiving said second input and responsively providing a second toggle switch function, and
a second power output toggled by said second toggle switch function responsive to the second output of the corresponding one of said at least one single switch; and
at least a pair of powered devices, each pair of said at least a pair of powered devices comprising a first powered device powered by the first power output of a corresponding one of said at least one switch module and a second powered device powered by the second power output of said corresponding one of said at least one switch module.

2. The vehicle of claim 1 wherein said each of said at least one switch module further comprises a processor including a non-volatile memory having said first and second electronic memories.

3. The vehicle of claim 1 wherein said first electronic memory is a first non-volatile latch and said second electronic memory is a second non-volatile latch.

4. The vehicle of claim 1 wherein said first electronic memory is a first non-volatile digital logic circuit and said second electronic memory is a second non-volatile digital logic circuit.

5. The vehicle of claim 1 wherein said first electronic memory is a first non-volatile electronic memory and said second electronic memory is a second non-volatile electronic memory.

6. The vehicle of claim 1 wherein said first powered device is a powered spot light and said second powered device is a cruise control.

7. The vehicle of claim 1 wherein one of said first and second powered devices is a powered hazard light.

8. The vehicle of claim 1 wherein the first toggle switch function of said first electronic memory is structured to receive said first input corresponding to said first actuated position and responsively toggle power to said first powered device; and wherein the second toggle switch function of said second electronic memory is structured to receive said second input corresponding to said second actuated position and responsively toggle power to said second powered device.

9. The vehicle of claim 1 wherein said first and second power outputs are selected from the group consisting of field effect transistors, solid state relays and electro-mechanical relays.

10. The vehicle of claim 1 wherein said each of said at least one single switch is a single rocker switch which further comprises a first indicator driven by the first power output and a second indicator driven by the second power output.

11. A single switch apparatus comprising:
a single switch comprising:
an operator including a non-actuated position, a first actuated position, and a second different actuated position,
a first output corresponding to said first actuated position, and
a second output corresponding to said second different actuated position; and
a switch module operatively associated with said single switch, said switch module comprising:
a first input electrically interconnected with the first output of said single switch,
a first electronic memory receiving said first input and responsively providing a first toggle switch function,
a first power output toggled by said first toggle switch function responsive to the first output of said single switch, said first power output being structured to power a first powered device,
a second input electrically interconnected with the second output of said single switch,
a second electronic memory receiving said second input and responsively providing a second toggle switch function, and
a second power output toggled by said second toggle switch function responsive to the second output of said single switch, said second power output being structured to power a second powered device.

12. The single switch apparatus of claim 11 wherein the first toggle switch function of said first electronic memory is structured to receive said first input corresponding to said first actuated position and responsively toggle power to said first powered device; and wherein the second toggle switch function of said second electronic memory is structured to receive said second input corresponding to said second actuated position and responsively toggle power to said second powered device.

13. The single switch apparatus of claim 12 wherein when said first powered device is powered and when the first toggle switch function of said first electronic memory receives said first input corresponding to said first actuated position, said first power output responsively removes power from said first powered device.

14. The single switch apparatus of claim 11 wherein when said second powered device is unpowered and when the second toggle switch function of said second electronic memory receives said second input corresponding to said second actuated position, said second power output responsively restores power to said second powered device.

15. A switch module apparatus for a single switch of a vehicle, said single switch comprising an operator including a non-actuated position, a first actuated position, and a second different actuated position; a first output corresponding to said first actuated position; and a second output corresponding to said second different actuated position; said switch module apparatus comprising:
a first input structured to be electrically connected to the first output of said single switch;
a first electronic memory receiving said first input and responsively providing a first toggle switch function;
a first power output toggled by said first toggle switch function responsive to the first output of said single switch, said first power output being structured to power a first powered device;
a second input structured to be electrically connected to the second output of said single switch;
a second electronic memory receiving said second input and responsively providing a second toggle switch function; and
a second power output toggled by said second toggle switch function responsive to the second output of said single switch, said second power output being structured to power a second powered device.

16. The switch module apparatus of claim 15 wherein the first toggle switch function of said first electronic memory is structured to receive said first input corresponding to said first actuated position and responsively toggle power to said first powered device; and wherein the second toggle switch function of said second electronic memory is structured to receive said second input corresponding to said second actuated position and responsively toggle power to said second powered device.

17. The switch module apparatus of claim 15 wherein when said first power output is unpowered and when the first toggle switch function of said first electronic memory receives said first input corresponding to said first actuated position, said first power output is structured to restore power.

18. The switch module apparatus of claim 15 wherein when said second power output is powered and when the second toggle switch function of said second electronic memory receives said second input corresponding to said second actuated position, said second power output is structured to remove power.

19. The switch module apparatus of claim 15 wherein said first power output includes a first output structured to power said first powered device and a second output structured to power an indicator.

20. The switch module apparatus of claim 15 wherein said second power output includes a first output structured to power said second powered device and a second output structured to power an indicator.
